(19) United States
(12) Patent Application Publication
(10) Pub. No.: US 2013/0113704 A1
(43) Pub. Date: May 9, 2013

(54) DATA FUSION AND MUTUAL CALIBRATION FOR A SENSOR NETWORK AND A VISION SYSTEM

(71) Applicant: The Regents of the University of California, Oakland, CA (US)

(72) Inventors: Majid Sarrafzadeh, Anaheim Hills, CA (US); Ming-Chun Huang, Culver City, CA (US); Ethan Chen, San Diego, CA (US); Yi Su, Gainesville, FL (US); Wenyao Xu, Rowland Heights, CA (US)

(73) Assignee: The Regents of the University of California, Oakland, CA (US)

(21) Appl. No.: 13/668,159

(22) Filed: Nov. 2, 2012

Related U.S. Application Data
(60) Provisional application No. 61/556,053, filed on Nov. 4, 2011.

(51) Int. Cl. G06F 3/033

(52) U.S. Cl. 345/158

(57) ABSTRACT

A system includes a contoured sensor network including a plurality of sensors. Each sensor provides sensor information indicating a movement of at least one portion of the sensor network. The system further includes a vision system and a reconciliation unit that receives sensor information from the contoured sensor network, receives location information from the vision system, and determines a position of a portion of the contoured sensor network. The reconciliation unit further calculates an error and provides calibration information based on the calculated error.

### CROSS-REFERENCE TO RELATED APPLICATION

This application claims priority to U.S. Provisional Patent Application Ser. No. 61/556,053 filed Nov. 4, 2011 to Sarrafzadeh et al., entitled “Near Realistic Game-Based Rehabilitation,” the contents of which are incorporated herein in their entirety.

### BACKGROUND

An object location monitoring system may need to accurately track fine movement. However, sensors in such systems often suffer from increasing tracking errors as a system is used. Thus, it would be beneficial for a system to have good resolution, and further to have automatic calibration to maintain an acceptable level of accuracy. Moreover, it would be beneficial for such a system to be usable in a variety of locations and by a variety of users with different capabilities.

### SUMMARY

A location monitoring system uses information received from a contoured sensor network and information received from a vision system to determine location information and calibration values for one or both of the contoured sensor network and vision system, allowing for reliable tracking of small movement within a three-dimensional space. Calibration values may be determined when the contoured sensor network is within a detection zone of the vision system. Determination of calibration values may be performed automatically, and may be performed continuously or periodically while the contoured sensor network is in the detection zone of the vision system. Once calibrated, the contoured sensor network may be used outside the detection zone of the vision system.

The contoured sensor network is configured to be positioned on a moving object for detection of movement of portions of the moving object. In some implementations, the moving object is a human, and the contoured sensor network is contoured to a portion of the human body.

In some implementations, a contoured sensor network is a wearable sensor network.

### BRIEF DESCRIPTION OF THE DRAWINGS

FIG. 1 illustrates an example location monitoring system.

FIG. 2 illustrates an example of usage of a location monitoring system.

FIG. 3A illustrates an example of a portion of a contoured sensor network.

FIG. 3B illustrates an example of a portion of a contoured sensor network.

FIG. 4 illustrates an example methodology used in a location monitoring system.

### DETAILED DESCRIPTION

A calibratable location monitoring system includes a contoured sensor network and a vision system. A reconciliation unit receives location and motion information from the vision system and the contoured sensor network, and determines calibration values from the information received. The calibration values are then provided to one or both of the contoured sensor network and vision system for calibration. Calibration may be performed manually following a calibration procedure. However, a manual calibration procedure may be time consuming and error prone. Thus, automatic calibration is implemented within the location monitoring system, such that when the contoured sensor network is in use, the vision system may also be providing information that is used for calibrating the contoured sensor network and vision system. Calibration may be continuous, such that when one calibration cycle finishes, the next one begins. Calibration may be periodic, triggered by, for example, a timer. Calibration may be performed when information from the vision system indicates that an error in the data from one or more sensors in the contoured sensor network is greater than, equal to, or less than a threshold.

As one example, a vision system may be used in a manufacturing setting to identify a three-dimensional position of a mechanical arm, and a contoured sensor network may be used to identify a multi-dimensional relative motion of a portion of the mechanical arm. The position information from the vision system may be used to calibrate the contoured sensor network so that the multi-dimensional relative motion is reported accurately with respect to a known position. The arm may then be controlled using the information from the calibrated contoured sensor network.

As another example, a contoured sensor network may be used to identify multi-dimensional relative motion of a portion of a person. An entertainment system may use one or more contoured sensor networks to identify movement of a user's fingers, for example, as the user interacts with a video game on a video screen. A vision system may be included in the entertainment system to identify a position of the hand. The position and movement information are fused into a combined overlay position. The information from the contoured sensor network and the vision system is used to determine errors, and from the errors, calibration values are calculated to adjust for the errors.

In some implementations, a contoured sensor network is a wearable sensor network. For example, a wearable sensor network may be a glove or partial glove that locates various sensors around one or more finger joints to recognize three-dimensional position and motion of the joints. Other examples of a wearable sensor network include shoes or insoles with pressure sensors, a pedometer for foot modeling and speed, an earring or necklace with a microphone for distance ranging, a watch, wristband, or armband with pressure sensors, and an inertial measurement unit (IMU) for arm movement modeling.

External sensors may augment a contoured sensor network, such as using RFID tags or the like to provide location information related to the contoured sensor network, or related to objects in the nearby environment. For example, radio frequency identification (RFID) tags may be placed around a periphery of a use environment, and as a contoured sensor network approaches an RFID tag, a warning may be provided. In an entertainment system, for example, a vibration signal may be sent to a wearable sensor network in a shoe to indicate that the user stepped out of bounds.

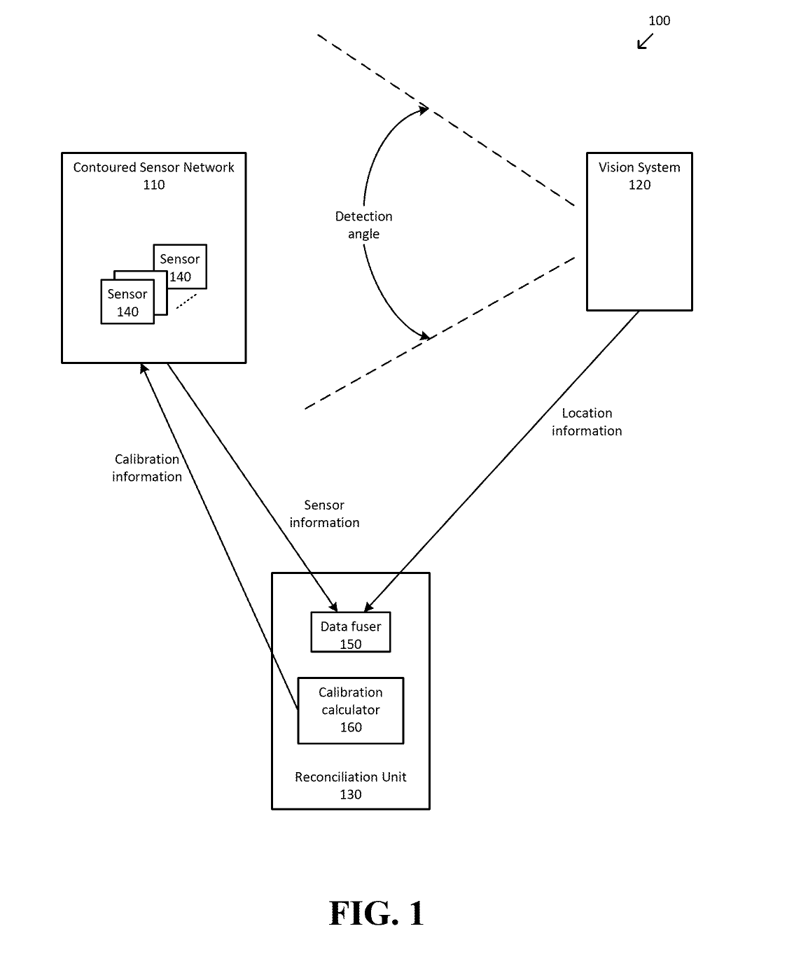

FIG. 1 is an example of a calibratable location monitoring system 100 that includes a contoured sensor network 110, a vision system 120, and a reconciliation unit 130. Information from sensor network 110 and from vision system 120 is used to calculate calibration values, which are provided to sensor network 110.

Contoured sensor network 110 is generally contoured according to the contour of a particular area of interest of an object. In some implementations, however, contoured sensor network 110 is designed without a target object in mind, and is instead designed to accommodate a variety of contours. For example, contoured sensor network 110 may be a strip of flexible material with multiple sensors. The strip of flexible material may be placed on the skin of a human to monitor limb movement. The same strip of flexible material may also be used to monitor proper positioning of a moving portion of a machine.

Vision system 120 uses one or more cameras or other visioning systems to determine a two-dimensional (2D) or three-dimensional (3D) relative position of an object within a detection zone. The detection zone includes a physical area described by a detection angle (as illustrated) and a detection range (not shown). Detection angle may vary by plane. For example, in FIG. 1, the detection angle is illustrated in a vertically-positioned plane, and if the detection angle is equal in every other plane to the detection angle in the vertical plane, a cone-shaped detection zone is defined. Detection range is the distance from vision system 120 to an object for substantially accurate recognition of the object, and may vary within the detection zone. For example, detection range may be less in the outer periphery of the detection zone than it is in the center. The overall shape of the detection zone will vary with the number, type(s), and placement of vision devices used in vision system 120. In some implementations, the detection zone may surround vision system 120. For example, the detection zone may be generally spherical with vision system 120 at or near the center.

A vision system 120 may perform 2D or 3D positioning using one or more methods. For example, one or more of visible light, infrared light, audible sound, and ultrasound may be used for positioning. Other positioning methods may additionally or alternatively be implemented.

One example of a vision system 120 is the Microsoft Kinect, a controller for the Xbox 360 console. The Kinect provides three-dimensional (3D) positional data for a person in its detection zone through use of a 3D scanner system based on infrared light. The Kinect also includes a visible light camera (“an RGB camera”) and microphones. The RGB camera can record at a resolution of 640×480 pixels at 30 Hz. The infrared camera can record at a resolution of 640×480 pixels at 30 Hz. The cameras together can be used to display a depth map and perform multi-target motion tracking In addition to the depth-mapping functionality, normal video recording functionality is provided. The Kinect is one example of the use of an existing system as a vision system 120. Other existing systems with different components may also be used as vision system 120. Additionally, a proprietary vision system 120 may be developed.

Reconciliation unit 130 receives sensor information from one or more contoured sensor networks 110 regarding relative motion of a monitored portion of an object. For example, reconciliation unit 130 may receive information regarding the change in position of a hand, along with information regarding the bending of fingers on the hand. Reconciliation unit 130 also receives location information from one ore more vision systems 120 regarding the relative position of portions of the object. Continuing with the example of the hand, information from vision system 120 may include 3D location information from various portions of a body including the hand.

Reconciliation unit 130 uses the information received from contoured sensor network 110 and vision system 120 to track fine resolution motion, and to determine calibration errors, and calculates calibration values to correct the errors. For example, angle offsets may be added to rotation measurements. The calibration values may be provided to contoured sensor network 110 for correction of sensor data. The calibration values alternatively may be used by reconciliation unit 130 to correct incoming data. In some implementations, calibration values are additionally or alternatively provided to vision system 120 or used by reconciliation unit 130 to correct data received from vision system 120.

Reconciliation unit 130 may be a stand-alone unit that includes analog, digital, or combination analog and digital circuitry, and may be implemented at least in part in one or more integrated circuits. Such a stand-alone unit includes at least an interface for communication with vision system(s) 120 and an interface for contoured sensor network(s) 110. Vision system(s) 120 and contoured sensor network(s) 110 may share the same interface, if using the same protocol, for example. A stand-alone unit may include methodologies implemented in hardware, firmware, or software, or some combination of hardware, firmware and software. A stand-alone unit may include an interface allowing for reprogramming of software.

Reconciliation unit 130 may be part of an external device, such as a computer or a smart phone or other computing device. For example, reconciliation unit 130 may be a methodology or set of methodologies stored as processor instructions in a computer, using the interfaces of the computer to communicate with contoured sensor network 110 and vision system 120.

Reconciliation unit 130 may be included as part of vision system 120. For example, reconciliation unit 130 may be a methodology or set of methodologies stored as processor instructions in vision system 120, using the interfaces of vision system 120 to communicate with contoured sensor network 110.

Reconciliation unit 130 may be included as part of contoured sensor network 110. For example, reconciliation unit 130 may be a methodology or set of methodologies stored as processor instructions in contoured sensor network 110, using the interfaces of contoured sensor network 110 to communicate with vision system 120.

Sensors 140 are placed strategically in or on a contoured sensor network 110 to gather information from a particular area of an object. At least one of the sensors 140 of a contoured sensor network 110 is calibratable, such that the response at the output of the sensor to a stimulus at the input of the sensor may be adjusted by changing a calibration value of the sensor. Sensors 140 may include one or more of an accelerometer, compass, gyroscope, pressure sensor, and proximity sensor, as some examples. Contoured sensor network 110 may further include sensors unrelated to position. For example, the glove mentioned above may be used in rehabilitation, and medical sensors may be included in the glove for monitoring vital signs of a patient during a therapy session, such as temperature, pressure map, pulse sequence, and blood oxygen density sensors.

A contoured sensor network 110 may include a feedback mechanism to provide feedback to the monitored object. In the example given above of a glove, sensors 140 in the glove may detect movement towards a virtual object, and detect when the sensors 140 indicate that the glove has reached a position representing that the virtual object has been “touched.” A virtual “touch” may cause a feedback mechanism in the glove to provide force to the finger(s) in the area of the glove which “touched” the virtual object, to provide tactile feedback of the virtual touch. One example of a haptic feedback device is a shaftless vibratory motor, such as the motor from Precision Microdrive.

Sensors 140 may be part of the structure of a contoured sensor network 110, which may be formed of one or more of a variety of materials. A few of the available materials that perform the function of a sensor 140 include: piezoresisitive material designed to measure pressure, such as an eTextile product designed at Virginia Tech; resistive-based membrane potentiometer for measuring bend angle, such as the membrane from Spectra Symbol; and pressure sensitive ink, such as the product from Tekscan.

Some materials, such as pressure sensitive ink or fabric coating, use specific material characteristics to calculate pressure. Resistance may vary based on the contact area of a multilayer mixed materials structure. Force applied to a sensor will compress the space between the mixed materials such that the contact area of the materials increases and resistance correspondingly decreases. This relationship is described in Equation (1).

$$Resistance = material coefficient \times \frac{material Length}{Contact Area} \qquad ( 1 )$$

Resistance of the material is not linearly proportional to force, but is rather more of an asymptotic curve. A material may be characterized according to its conductance, which is the inverse of resistance, as shown in Equation (2).

$$Conductance = \frac{1}{Resistance} \qquad ( 2 )$$

Conductance and imposed force have a linear minimum mean square error relationship, meaning that more force applied results in more voltage or current.

Sensors 140 may include one or more inertial measurement units (IMU) for combined motion and orientation measurement. One example of an IMU is a Razor IMU-AHRS, which includes an Arduino hardware controller, a three-axis digital accelerometer, a three-axis digital compass, and a three-axis analog gyroscope.

An IMU may provide information with respect to several translational displacement measurements: x, y, and z in a three-dimensional space; rotation angle; pitch, roll, and yaw. Yaw may be separately calculated using others of the measurements. The number of measurements results in computational complexity, which may cause computational error.

Sensors 140 may exhibit a change in characteristics over time or in different environments. For example, piezoresistive elements exhibit time-based drift. For another example, an accelerometer, gyroscope and compass may be susceptible to a variety of noise, such as power variance, thermal variance, environmental factors, and Coriolis Effect. Such noise sources are generally random and may be difficult to remove or compensate.

Frequent calibration mitigates errors from computation, drift, age, noise, and other error sources. One example of calibration is a method of calibrating for the x, y, and z displacements in an accelerometer. The accelerometer is flipped in six directions, holding position for a time in each direction. Offset and gain terms may be calculated based on acceleration as shown in Equations (3) and (4).

Offset=½(Accel., one direction+Accel., opposite direction) (3)

Gain=½ (Accel., one direction−Accel., opposite direction) (4)

However, the six-flip method calibrates only a portion of an IMU, and may be error prone. Other sensors have different calibration methods, and each method may include multiple steps. Thus, when a contoured sensor network 110 includes multiple sensors and multiple types of sensors, calibration of each of the sensors individually would be time-consuming and error prone, and automatic calibration would be preferable.

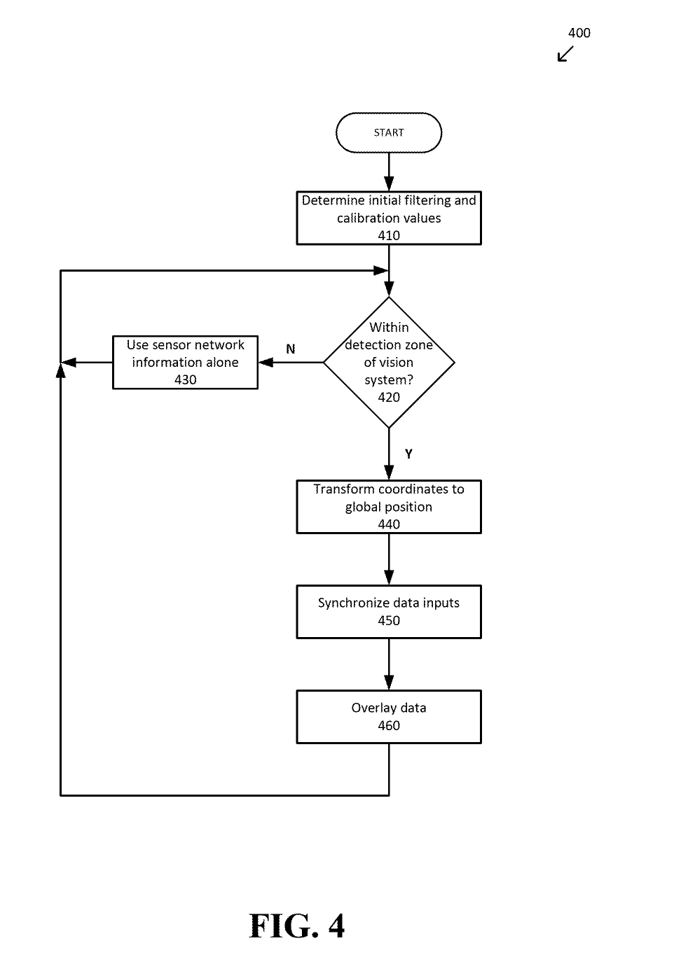

Data fuser 150 of reconciliation unit 130 translates the information from contoured sensor network(s) 110, vision system(s) 120, and other relevant sensors in system 100 into useful formats for comparison, and uses the translated data to create a combined overlay position. One implementation of data fusion is described below by way of example with respect to FIG. 4. The combined overlay position may be stored in a memory at each sample point in a time period, and used later for reconstruction of the sequence of movement. The sequence of movement may also be displayed visually by mapping the combined overlay position onto pixels of a display. The visual replay capability may be used to evaluate the movement sequence. For example, the combined overlay position information or the replay information may be provided to a remote therapist to evaluate progress of a patient.

Calibration calculator 160 uses the translated data generated by data fuser 150 to determine incoherencies in the data representing differences in the information received from different parts of system 100. If there are differences, calibration calculator 160 determines the source of the error(s), and calculates calibration values to correct the error(s). The calibration values are provided to the contoured sensor network(s) 110, vision system(s) 120, and other relevant sensors in system 100, as appropriate.

Communication between various components of system 100 may be through wired or wireless connections (not shown), using standard, semi-standard, or proprietary protocols. By way of example, in one implementation, vision system 120 communicates with reconciliation unit 130 via a wired Universal Serial Bus (USB) protocol connection, reconciliation unit 130 communicates with contoured sensor network 110 wirelessly using a Bluetooth protocol connection, and another relevant sensor in system 100 communicates with reconciliation unit 130 via a proprietary wireless protocol.

An example given above of a vision system 120 was the Kinect. The Kinect may be attached to a personal computer or Xbox, which includes a USB interface and provides wireless data communication functionality such as WiFi, Bluetooth, or ZigBee. Thus, the Kinect provides communication interfaces that may be used in a system 100 for enabling wireless synchronization between vision system 120, contoured sensor network 110, and reconciliation unit 130. Further, the computer or Xbox includes an Ethernet or other protocol network connection, which may be used for remote monitoring or data storage.

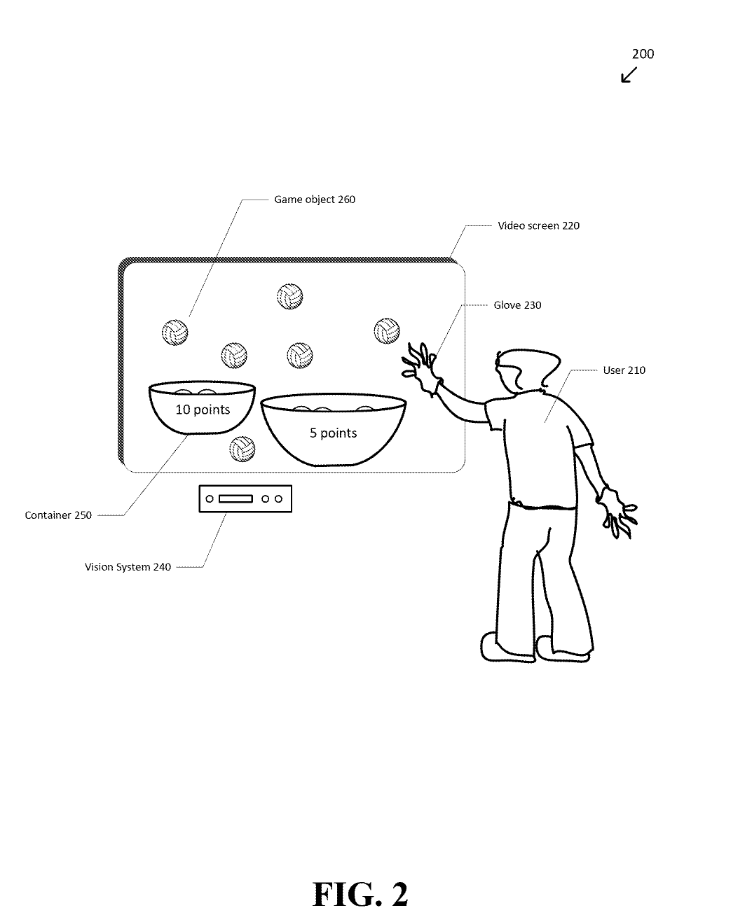

FIG. 2 illustrates an example system 200 that may be used for rehabilitation in the context of physical therapy, included to promote understanding of how a system 100 may be implemented. FIG. 2 includes illustrations of a user 210 interacting with a virtual display on a video screen 220. User 210 is wearing two gloves 230 which are examples of contoured sensor networks 110. A vision system 240 is positioned such that user 210 is in the detection zone of vision system 240 at least part of the time while interacting with the virtual display. The virtual display includes two containers 250, the larger of which is labeled “5 points” and the smaller of which is labeled “10 points,” indicating that for this particular task, more points are awarded for finer motor control. The virtual display also includes multiple game objects 260.

As illustrated, user 210 wearing gloves 230 “touches” or “grabs” a game object 260 on the virtual display and respectively “drags” or “places” the game object 260 into one of the containers 250. Containers 250 already include several game objects 260, indicating that user 210 has been using the system for a time already.

When user 210 is within the detection zone of vision system 240, system 200 may automatically detect that user 210 is in the detection zone and may initiate calibration of gloves 230 and/or vision system 240. Alternatively or additionally, system 200 may perform calibration upon a manual initiation.

In a system such as illustrated in FIG. 2, the content and difficulty of the game may be selected for a user's age and therapy needs. The game may include a timer, and may further include a logging mechanism to track metrics. For example, metrics such as time per task, duration of play, frequency of play, accuracy, and number of points may be tracked, as well as trends for one or more of these or other metrics.

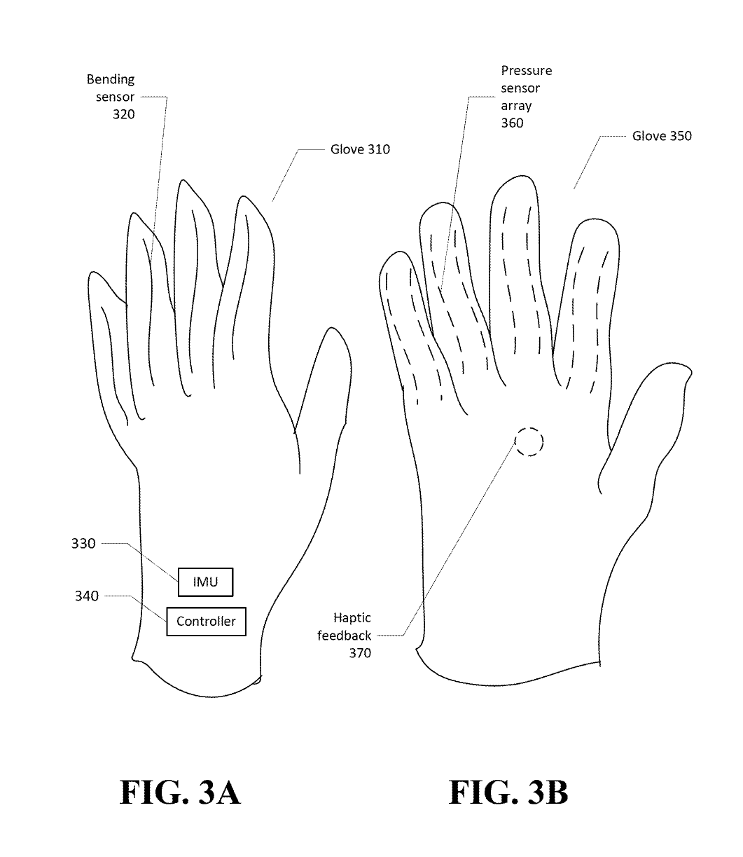

FIGS. 3A and 3B illustrate example contoured sensor networks 110 in the form of gloves. For the glove, finger bend angle may be initially calibrated when the hand is closed (90 degrees) or fully opened (0 degrees), and pressure may be calibrated when the hand is loaded and unloaded.

FIG. 3A illustrates the back of a glove 310. As illustrated, bending sensors 320 may be positioned along each finger (and along the thumb, not shown) of glove 310. Other bending sensors 320 may be placed at other locations of glove 310 as well. An IMU 330 is illustrated near the wrist portion of glove 310 for detecting wrist movement and rotation. Other IMUs may also be included, and an IMU may be placed in other locations of glove 310. Controller 340 includes interfaces, processing, and memory for gathering data from the multiple sensors in glove 310, filtering the data as appropriate, applying calibration values to the data, and providing the data externally. For example, controller 340 may include amplifiers, analog-to-digital converters, noise reduction filters, decimation or other down-sampling filters, smoothing filters, biasing, etc. Controller 340 may be implemented in analog, digital, or combination analog and digital circuitry, and may be implemented at least in part in one or more integrated circuits.

FIG. 3B illustrates the front of a glove 350. As illustrated, pressure sensor arrays 360 may be positioned along each finger (and along the thumb, not shown) of glove 350. Individual pressure sensors may be used alternatively to the pressure sensor arrays. Other pressure sensors or pressure sensor arrays 360 may be included at other positions on glove 350. A haptic feedback device 370 is illustrated in the center of glove 350 for providing notifications to a user.

Contoured sensor network 110 and vision system 120 may provide different types of information about the same movement. For example, contoured sensor network 110 may provide high resolution relative movement information for a portion of an object, whereas vision system 120 may provide low resolution position information for several portions of the object. Reconciliation unit 130 fuses the data into a combined overlay position.

FIG. 4 is an example of a methodology 400 for fusing data from a contoured sensor network 110 and a vision system 120. The methodology begins at methodology block 410, by reconciliation unit 130 determining initial filtering and calibration values for contoured sensor network 110 and vision system 120. Initial predictions for the values may be based on data from sensor datasheets or the like, from historical data, from prior testing, or from manual calibration, for example. The initial predictions may be adjusted at startup by recognizing a known state for the contoured sensor network 110 and calibrating accordingly. For example, at startup of the system using a glove, a hands-at-rest state may be recognized by the hands hanging statically downward, and the position data from the glove may be used to determine measurement error for that state and corresponding calibration values for the glove. Methodology 400 continues at decision block 420 after initialization in methodology block 410.

At decision block 420, reconciliation unit 130 determines whether contoured sensor network 110 is within the detection zone of vision system 120. If not, methodology 400 continues at methodology block 430, where information from contoured sensor network 110 is used without corroboration from vision system 120, then methodology 400 continues at decision block 420. If contoured sensor network 110 is within the detection zone of vision system 120, methodology 400 continues at methodology block 440.

At methodology block 440, reconciliation unit 130 transforms position information received from contoured sensor network 110 and vision system 120 into positioning coordinate data. For example, the sensors in a glove may provide position information in translational terms, such as movement over a certain distance in a certain direction, and the translational terms are transformed to positioning coordinate data in a known three-dimensional space using the position information from vision system 120. Methodology 400 continues at methodology block 450.

At methodology block 450, reconciliation unit 130 synchronizes the positioning coordinate data from contoured sensor network 110 and vision system 120. Timestamps may be used for synchronization if both contoured sensor network 110 and vision system 120 have stayed in communication with reconciliation unit 130 since initialization, or if the communication protocol or reconciliation unit 130 includes a method of resynchronization after dropout. In addition to timestamps, reconciliation unit 130 compares the data from contoured sensor network 110 and vision system 120 for integrity. If there is disparity beyond a predefined threshold, reconciliation unit 130 determines whether to use none of the data or to use only part of the data. If the data from contoured sensor network 110 and vision system 120 is being stored, the data may be marked as unsynchronized. In some implementations, a loss of synchronization will result in a check of the communication signal strength and a possible increase in signal output power.

As an example, with respect to the glove implementation, if the glove reports that it has moved several inches but vision system 120 indicates no movement, reconciliation unit 130 may determine that accurate information is currently not being received from vision system 120 (due to noise, communication failure, power off, etc.) and that the information should be discarded. If information from contoured sensor network 110 and vision system 120 is consistent, the information is used by reconciliation unit 130 at methodology block 460.

At methodology block 460, the data of contoured sensor network 110 is overlaid on the data of vision system 120. For example, vision system 120 may provide positional information in coarse units, and contoured sensor network 110 may provide movement information in finer units. The fine detail is overlaid over the coarse information and the combined overlay position used, for example, as feedback for the movement taken. The overlay information may be stored in a memory for later access.

With respect to the glove implementation, for example, vision system 120 may provide general position of a user's torso, limbs and extremities, and the glove may provide detail of finger movements to overlay on general hand position information. The combined overlay position may be displayed in near real-time on a video screen to provide visual feedback for the person using the glove. The combined overlay position may be stored for later analyses or reconstruction. With respect to the manufacturing facility implementation, for another example, vision system 120 may provide position information for the main structures of a robotic arm, and contoured sensor network 110 may provide detail of the grasping and placement mechanisms on the arm. The combined overlay position may be used to verify proper function of the robotic arm. The overlay data may be used in raw form, or may be converted to another form, such as visual data used by a machine vision system for quality control.

Following methodology block 460, methodology 400 returns to decision block 420 to consider the next information from contoured sensor network 110 and vision system 120.

As mentioned above, the environment, calculation complexity, and sensor drift, among other sources, may cause errors to accumulate in the measurements provided by the sensors of the contoured sensor network 110, and regular calibration may be required. Manual calibration methods may themselves be error-prone, and may further be time-consuming. Thus, regular automatic calibration is preferable.

In some implementations, sensor data fusion and calibration is performed concurrently. An example of concurrent sensor data fusion and calibration is presented in the context of fusing IMU data and vision system 120 data. In this example, reconciliation unit 130 includes a Kalman filter derived displacement correction methodology that adapts coefficients, predicts the next state, and updates or corrects errors. Before initiating the methodology, several parameters are computed, such as IMU data offset values. An IMU's neutral static state values are not zeroes, and are computed by averaging. Additionally, the Kalman filter includes a covariance matrix for determining weighting of each distinct sensor source. For example, if a sensor has smaller variance in the neutral static state, it may be weighted more than other sensors that produce dampened data. The covariance matrix can be built by computing the standard deviation of each individual sensor input stream followed by computing the correlation between each of the sensor values in a time period following device power-on. The mean and standard deviation may also be computed by sampling for a period of time.

For the first stage of the Kalman filter, the variable x is defined as pitch, roll, and yaw, the variable u is defined as the integral of the gyroscope readings, and the variable z is defined as the angle readings from the accelerometer (pitch and roll) and the compass reading (yaw angle). For the second stage of the Kalman filter, the variable x is defined as the x, y, and z displacements, the variable u is defined as the double integral of the accelerometer readings, and the variable z is defined as the tilt derived from the vision system's transformed displacement value. The constants A, B, C are the system parameters that govern kinetics of the object movement, which can be calculated by learning with an iterative maximum likelihood estimate for the intrinsic parameters (i.e., an expectation maximization methodology).

Prediction in the displacement correction methodology may be based at least in part on models constructed over time. Models may be constructed offline and included in a library of information in reconciliation unit 130. Models may be constructed or modified during use of the system.

Thus, the displacement correction methodology of the example calculates errors as it fuses data, and the calculated errors are then used to provide calibration values to contoured sensor network 110 and vision system 120 as applicable. The displacement correction methodology may be expanded to include additional sensor inputs and additional information from vision system 120.

The displacement correction methodology as described above incorporates a Kalman filter. Other implementations may use different techniques for determining calibration values and fusing data. Additionally, calibration and data fusion may be performed separately.

Referring again to FIG. 4, the displacement correction methodology as described includes much of the functionality described regarding methodology 400.

A contoured sensor network 110 may be used with multiple vision systems 120, and a vision system 120 may be used with multiple contoured sensor networks 110. In the example given above of a glove used in a rehabilitative program, the glove could be used both with a vision system 120 at home and a vision system 120 at the therapists office, for example. Further, vision system 120 at home may be used not just with a glove, but with other contoured sensor networks 110 as well. Additionally, vision system 120 at the therapist's office may be used with contoured sensor networks 110 of multiple patients. Moreover, a vision system 120 may be mobile, moved between patient locations. Each time a contoured sensor network 110 is paired with a vision system 120, mutual calibration is performed. The calibration values calculated by the local reconciliation unit 130 for the contoured sensor network 110 may be saved to a memory. For example, calibration values may be stored in a computer memory, a mobile phone memory, or a memory card or other memory device. When the contoured sensor network 110 is then to be used with a different vision system 120, the stored values may be uploaded from the memory to the local reconciliation unit 130 as the initial calibration values.

### Conclusion

An embodiment of the invention relates to a non-transitory computer-readable storage medium having computer code thereon for performing various computer-implemented operations. The term “computer-readable storage medium” is used herein to include any medium that is capable of storing or encoding a sequence of instructions or computer codes for performing the operations, methodologies, and techniques described herein. The media and computer code may be those specially designed and constructed for the purposes of the invention, or they may be of the kind well known and available to those having skill in the computer software arts. Examples of computer-readable storage media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (“ASICs”), programmable logic devices (“PLDs”), and ROM and RAM devices.

Examples of computer code include machine code, such as produced by a compiler, and files containing higher-level code that are executed by a computer using an interpreter or a compiler. For example, an embodiment of the invention may be implemented using Java, C++, or other object-oriented programming language and development tools. Additional examples of computer code include encrypted code and compressed code. Moreover, an embodiment of the invention may be downloaded as a computer program product, which may be transferred from a remote computer (e.g., a server computer) to a requesting computer (e.g., a client computer or a different server computer) via a transmission channel. Another embodiment of the invention may be implemented in hardwired circuitry in place of, or in combination with, machine-executable software instructions.

While the invention has been described with reference to the specific embodiments thereof, it should be understood by those skilled in the art that various changes may be made and equivalents may be substituted without departing from the true spirit and scope of the invention as defined by the appended claims. In addition, many modifications may be made to adapt a particular situation, material, composition of matter, method, operation or operations, to the objective, spirit and scope of the invention. All such modifications are intended to be within the scope of the claims appended hereto. In particular, while certain methods may have been described with reference to particular operations performed in a particular order, it will be understood that these operations may be combined, sub-divided, or reordered to form an equivalent method without departing from the teachings of the invention. Accordingly, unless specifically indicated herein, the order and grouping of the operations is not a limitation of the invention.

1. A system, comprising:
a wearable sensor network including a plurality of sensors, each sensor providing sensor information indicating a movement of at least one portion of the wearable sensor network;
a vision system; and
a reconciliation unit, the reconciliation unit configured to:
receive sensor information from the wearable sensor network;
receive location information from the vision system;
determine from the sensor information and the location information a position of a portion of the wearable sensor network;
calculate an error; and
provide calibration information for at least one of the wearable sensor network and the vision system based on the calculated error.

2. The system of claim 1, wherein the sensor information includes one of yaw, pitch, and roll.

3. The system of claim 1, wherein the wearable sensor network is configured for at least one of the plurality of sensors to be located over a joint of a moving object.

4. The system of claim 3, wherein the joint is a human finger joint.

5. The system of claim 1, wherein the vision system provides three-dimensional location information.

6. The system of claim 1, wherein the reconciliation unit is included in the vision system.

7. The system of claim 1, wherein the wearable sensor network is included in a glove.

8. A system, comprising:
a flexible contoured item configured to be placed on a corresponding contour of a moving object;
a plurality of sensors coupled to the flexible contoured item, each sensor providing sensor information indicating a movement of at least one portion of the flexible contoured item; and
a calibration unit configured to:
communicate with the plurality of sensors;
receive information from an external vision system; and
calibrate at least one of the plurality of sensors based at least in part on the information received from the external vision system.

9. The system of claim 8, wherein the information from the external vision system is three-dimensional location information.

10. The system of claim 8, wherein the flexible contoured item is configured for placement on one of a knee, an elbow, and an ankle

11. The system of claim 8, wherein the sensor information includes one of yaw, pitch, and roll.

12. The system of claim 8, wherein the flexible contoured item is configured for at least one of the plurality of sensors to be located over a joint of a moving object.

13. The system of claim 12, wherein the flexible contoured item is a glove and the joint is a human finger joint.

14. The system of claim 8, further comprising an interface to a remote computer system to allow for remote monitoring of a patient undergoing physical rehabilitation.

15. A method, comprising:
receiving sensor information from a first contoured sensor network;
receiving location information from a vision system;
determining from the sensor information and the location information a position of a portion of the first contoured sensor network;
calculate an error; and
provide calibration information for at least one of the first contoured sensor network and the vision system based on the calculated error.

16. The method of claim 15, wherein the calibration information is a sensor offset value for a sensor in the first contoured sensor network.

17. The method of claim 15, wherein the calibration information is a camera calibration value for a camera in the vision system.

18. The method of claim 15, wherein the first contoured sensor network and the vision system are included in a game system.

19. The method of claim 15, further comprising providing tactile feedback in response to the sensor information from the first contoured sensor network or the location information from the vision system.

20. The method of claim 15, further comprising:
saving the position of a portion of the contoured sensor network to a memory.

21. The method of claim 20, wherein the method is repeated such that the memory includes a sequence of data representing a sequence of positions of a portion of the contoured sensor network, further comprising:
reconstructing from the sequence of data a description of the motion of the portion of the contoured sensor network;
transforming the description of motion to a set of pixel values; and
providing the set of pixel values to a display for visual representation of the reconstructed sequence.
